(19) United States
(12) Patent Application Publication
(10) Pub. No.: US 2013/0189863 A1
(43) Pub. Date: Jul. 25, 2013

(54) CONNECTOR SYSTEM

(71) Applicants: Robert R. Genest, Ductchess, NY (US); Robert K. Mullady, Ulster, NY (US)

(72) Inventors: Robert R. Genest, Ductchess, NY (US); Robert K. Mullady, Ulster, NY (US)

(73) Assignee: INTERNATIONAL BUSINESS MACHINES CORPORATION, Armonk, NY (US)

(21) Appl. No.: 13/354,026

(22) Filed: Jan. 19, 2012

(51) Int. Cl. H01R 13/44

(52) U.S. Cl. 439/136

(57) ABSTRACT

A connector system is provided and includes a blind mate book including a chassis and a connector, which is extendable and retractable with respect to the chassis, a mating connector operably connectable with the connector and a blocking system defining a pathway through which the blind mate book travels toward and from a connect position defined as a position at which the connector is operably connectable with the mating connector. The blocking system is configured to at least one of prevent travel of the blind mate book toward and from the connect position with the connector partially extended, and to permit connector extension upon disposition of the blind mate book in the connect position.

### BACKGROUND

The present invention relates to a connector system and, more particularly, to a connector system for a blind mate book and a mating connector.

In various computing applications, it is often necessary to install memory or processor cards into a docking station of servers, personal computing devices, etc. Often, the cards include a chassis, an actuating mechanism, a printed circuit board (PCB) and a connector. The chassis supports the various components within an outer wall and is installed within a slot of the docking station, the PCB includes a plurality of electrical components for carrying out various application specific processes, the connector electrically couples the electrical components to a mating connector of the docking station within the slot and the actuating mechanism places the PCB and the connector in their correct positions once the chassis is installed within the slot.

Since the electrical leads for both the connector and the mating connector are relatively small and fragile, failures of the leads are prone to occur following improper installation of the cards. In particular, if the connector impacts the mating connector as the chassis is moved within the docking station, the leads can be bent or broken and may not connect properly with the corresponding leads of the connector.

### SUMMARY

According to an aspect of the present invention, a connector system is provided and includes a blind mate book including a chassis and a connector, which is extendable and retractable with respect to the chassis, a mating connector operably connectable with the connector and a blocking system defining a pathway through which the blind mate book travels toward and from a connect position defined as a position at which the connector is operably connectable with the mating connector. The blocking system is configured to permit connector extension upon disposition of the blind mate book in the connect position.

According to another aspect of the present invention, a connector system is provided and includes a blind mate book including a chassis and a connector, which is extendable and retractable with respect to the chassis, a mating connector operably connectable with the connector and a blocking system defining a pathway through which the blind mate book travels toward and from a connect position defined as a position at which the connector is operably connectable with the mating connector. The blocking system being configured to prevent travel of the blind mate book toward and from the connect position with the connector partially extended.

According to yet another aspect of the invention, a connector system is provided and includes a blind mate book including a chassis and a connector, which is extendable and retractable with respect to the chassis, a mating connector operably connectable with the connector and a blocking system defining a pathway through which the blind mate book travels toward and from a connect position defined as a position at which the connector is operably connectable with the mating connector. The blocking system is configured to prevent travel of the blind mate book toward and from the connect position with the connector partially extended, and to permit connector extension upon disposition of the blind mate book in the connect position.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a perspective view of a connector system in accordance with embodiments;

FIG. 2 is a perspective view of the connector system of FIG. 1 at an early, intermediate time;

FIG. 3 is a perspective view of the connector system of FIG. 1 at a later, intermediate time;

FIG. 4 is a side view of a rear portion of the connector system of FIG. 1; and

FIG. 5 is a side view of a key and lock feature of the connector system of FIG. 1.

### DETAILED DESCRIPTION

In accordance with aspects of the invention, a connector system 10 is provided for use with, for example, a blind mate book 20 and a mating connector 30 of a computing device 300. The connector system 10 is configured to prevent damage to electrical leads of both the blind mate book 20 and the mating connector 30 by preventing improper or incorrect installation of the blind mate book 20 into the computing device 300. For example, in various computing applications, it has been seen that devices similar to the blind mate book 20 are often installed with only partial connector retraction completed and with the connector thereby tending to impact and damage corresponding features. The connector system 10, as will be described below, cannot be installed or removed in such an improper manner.

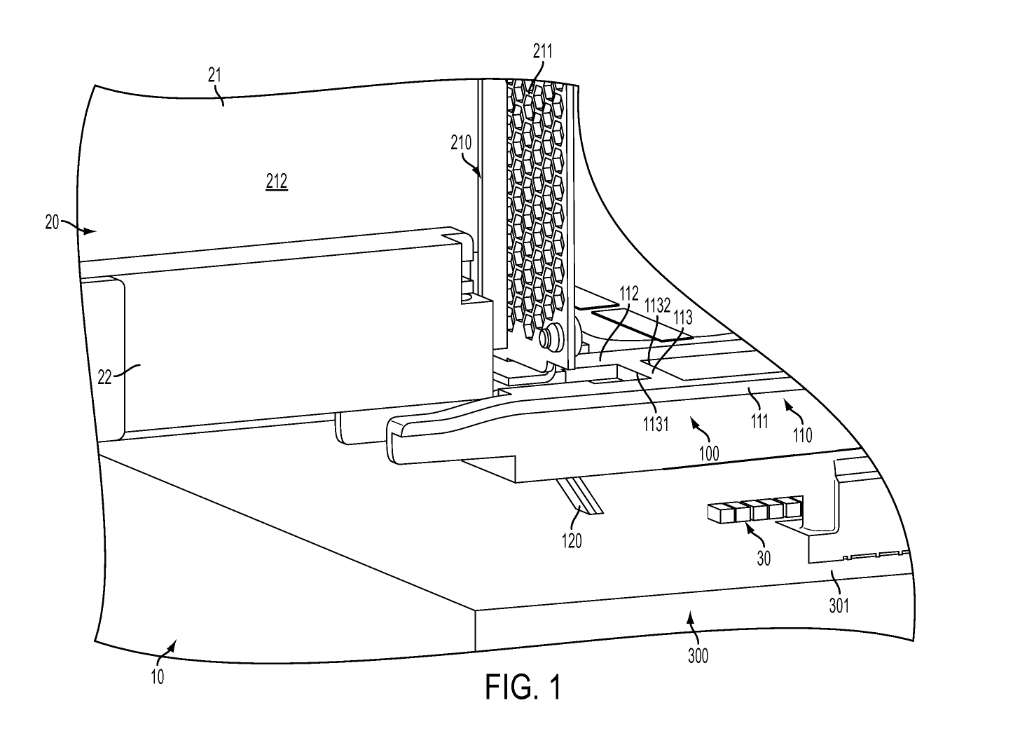

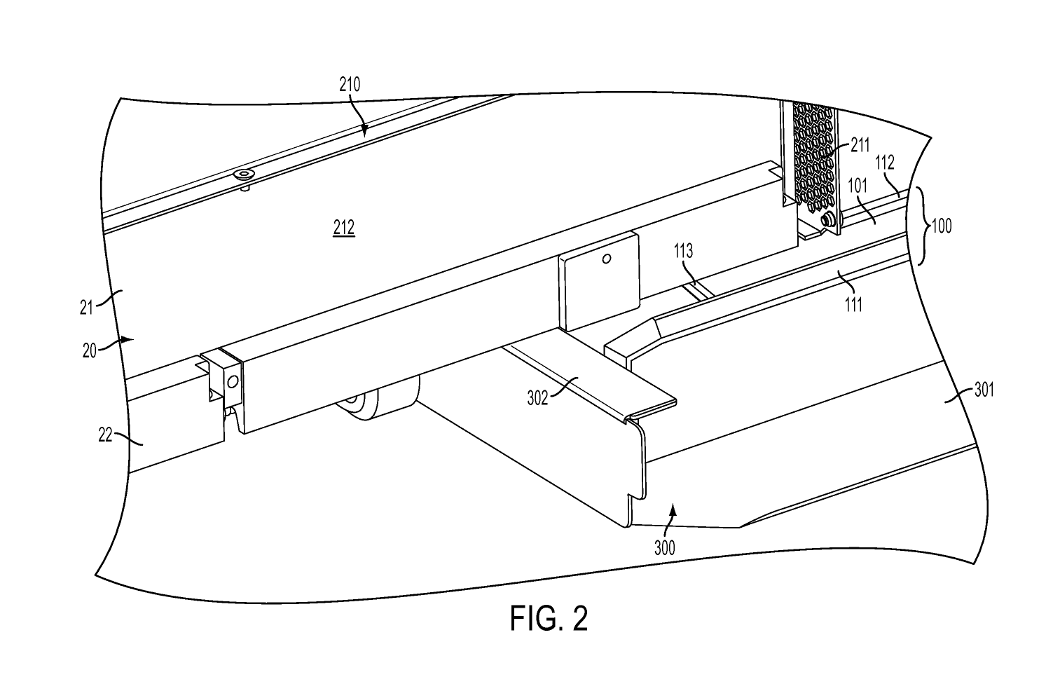

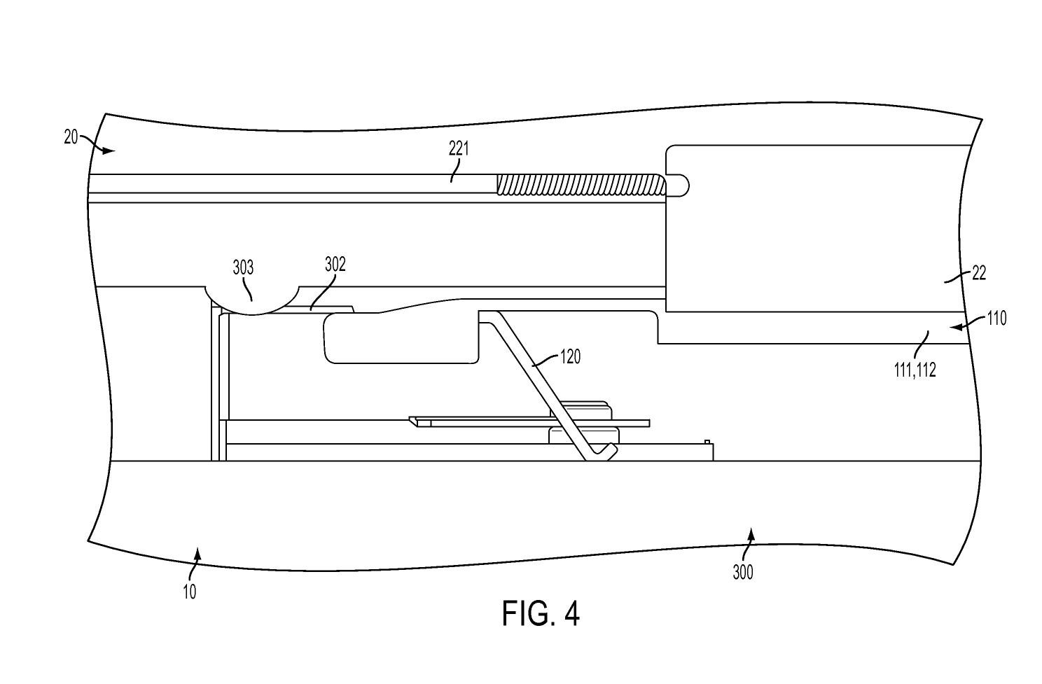

With reference to FIGS. 1 and 2, the blind mate book 20 includes a chassis 21 and a connector 22. The chassis 21 is a solid, rigid feature having an outer structure 210. The outer structure 210 includes a screen 211 for venting and cooling purposes and a track for facilitating blind mate book 20 installation into the computing device 300 and surrounds a printed circuit board (PCB) 212. The connector 22 is a volumetric element including a housing and an array of electrical leads disposed within the housing that are respectively coupled to various elements of the PCB 212. The connector 22 is coupled to the chassis 21 in a manner such that the connector 22 is extendable and retractable with respect to the chassis 21. The extension and retraction of the connector 22 may be conducted manually or with mechanical assistance (see screw 221 in FIG. 4) over a length of, in some cases, 10s of millimeters depending on an overall size of the various features described herein.

The computing device 300 may be any computing device, such as a server, a personal computer or a portable electronic device and may include a support structure 301 that defines along with additional structural elements an interior of the computing device 300. The blind mate book 20 is configured to be installed within this interior with the mating connector 30 being operably and supportively disposed on the support structure 301 such that the mating connector 30 is operably connectable with the connector 22. Thus, the mating connector 30 may include an array of electrical leads that are positioned to be respectively coupled to corresponding electrical leads of the connector 22.

In accordance with embodiments, the various components of the connector 22 and the mating connector 30 may be fragile and relatively easily damaged or dislocated. As such, contact between the connector 22 or any component of the blind mate book 20 and the mating connector 30 should be limited to contact occurring during proper installation processes. In addition, it is to be understood that the connector 22 and the mating connector 30 may be correspondingly singular and/or correspondingly plural in number.

The connector system 10 further includes a blocking system 100. The blocking system 100 is formed to define a pathway 101 through a constrained environment of the computing device 300. The constrained environment of the computing device 300 is formed by the various components of the computing device 300 that are both related and unrelated to the present description. The pathway 101 is a generally elongate pathway having dimensions that are slightly larger than corresponding dimensions of the blind mate book 20 such that relatively small clearances are provided about the blind mate book 20 during installation and removal processes. The blind mate book 20 thus travels along the pathway 101 during those installation and removal processes such that the blind mate book 20 travels toward and from a connect position. The connect position is defined herein as a position at which the electrical leads of the connector 22 are operably and safely connectable with or dis-connectable from the electrical leads of the mating connector 30. That is, the connect position is the position reached by the blind mate book 20 after traveling along the pathway 101 and the position from which the blind mate travels upon disconnection of the connector 22 from the mating connector 30.

With reference to FIGS. 1-5, the blocking system 100 is configured to prevent travel of the blind mate book 20 toward and from the connect position with the connector 22 partially extended with respect to the chassis 21. The blocking system 100 is further configured to permit connector 22 extension with respect to the chassis 21 upon and only upon disposition of the blind mate book 20 in the connect position.

In accordance with embodiments, the blocking system 100 may include a guide 110. The guide 110 is disposed proximate to the mating connector 30 within the computing device 300 and includes a first elongate leg 111, a second elongate leg 112 and a blocking leg 113. The first elongate leg 111 and the second elongate leg 112 may be disposed substantially in parallel with one another to define a general pathway about the pathway 101. The blocking leg 113 extends cross-ways between the first elongate leg 111 and the second elongate leg 112. In this position, the blocking leg 113 serves to prevent travel of the blind mate book 20 along the pathway 101 in a condition in which the connector 22 is partially extended with respect to the chassis 21. That is, as shown in FIG. 1, as the blind mate book 20 is improperly installed into the computing device 300, the screen 211 of the chassis 21 may clear the blocking leg 113 but the body of the connector 22 will not. The resulting impact between the connector 22 and the blocking leg 113 will indicate to an operator that the installation is being conducted improperly. In a similar vein, as shown in FIG. 4, during improper removal of the blind mate book 20 from the computing device 300 with the connector partially extended with respect to the chassis 21, a rear surface of the connector 22 may impact the blocking leg 113. This impact will, again, indicate to an operator that the removal of the blind mate book 20 from the computing device 300 is being conducted improperly.

The blocking leg 113 may include a forward side 1131 and an aft side 1132. The forward side 1131 thus impinges upon a lead side of the connector 22 to prevent travel of the blind mate book 20 toward the connect position with the connector 22 partially extended with respect to the chassis 21. The aft side 1132 impinges upon a trailing side of the connector 22, which is opposite the lead side, to prevent travel of the blind mate book 20 from the connect position with the connector 22 partially extended with respect to the chassis 21.

The guide 110 may be coupled to the support structure 301 at one end of the guide 110 and may rest upon an elastic element 120 at an opposite end thereof. The guide 110 is thereby spring loaded and configured to relatively softly withstand and absorb impacts between the blind mate book 20 and the guide 110 and between the blind mate book 20 and the blocking system 100. An overhand 302 may be provided as part of the support structure 301 and serves to limit movement of the guide 110 away from the support structure 301 in opposition to the bias of the elastic element 120. In accordance with embodiments, the first elongate leg 111 and the second elongate leg 112 may be tapered to fit underneath and/or to register with a downwardly facing surface of the overhang 302. Where the installation of the blind mate book 20 into the computing device 300 is completed, a gasket 303 (see FIG. 4) may be disposed between the chassis 21 of the blind mate book 20 and the overhang 302.

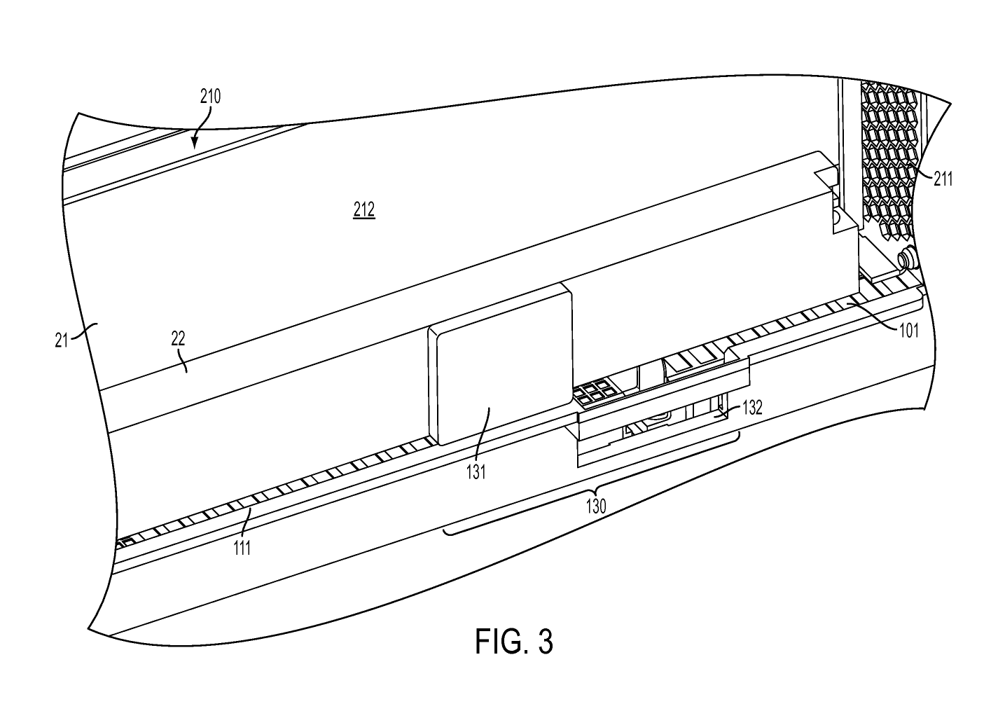

As shown in FIG. 3, the blocking system 100 further includes a key and key lock feature 130. Here, the connector 22 may include a key 131 coupled to a side of the connector 22 and the guide 110 may be formed to define a key lock 132. The key lock 132 is sized to be receptive of the key 131 during connector 22 extension upon and only upon disposition of the blind mate book 20 in the connect position. As shown in FIGS. 2 and 3, once the lead side of the connector 22 clears the blocking leg 113, the key 131 rides above a top facing surface of at least one of the first elongate leg 111 and the second elongate leg 112 (for purposes of clarity and brevity, it will be assumed that the key rides above the top facing surface of the first elongate leg 111). In this position, the key 131 prevents connector 22 extension with respect to the chassis 21 as the key 131 will impinge upon the top surface of the first elongate leg 111.

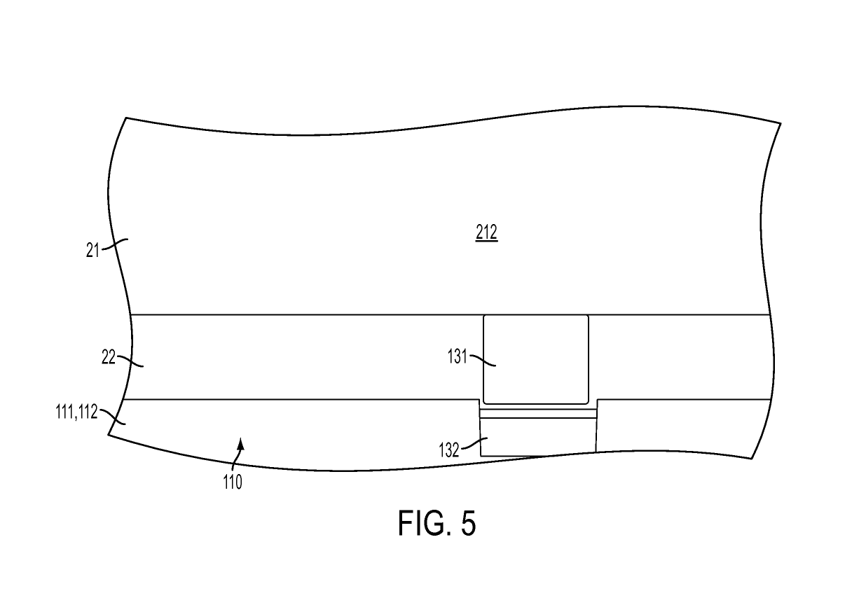

As shown in FIG. 5, however, once the blind mate book 20 reaches the connect position, the key 131 will be disposed above the key lock 132. Here, the key 131 will be receivable in the key lock 132 as the connector 22 is extended from the chassis 21. Moreover, it will be understood that the timing of the key 131 and the key lock 132 may be provided such that the bottom edge of the key 131 will impact with a bottom surface of the key lock 132 immediately following the disposition of the connector 22 in a vertical position at which the connector 22 and the mating connector 30 are to be connected under proper conditions. As such, the key 131 and the key lock 132 serve as a mechanical stop whereby excessive extension of the connector 22 with respect to the chassis 21 may be prevented.

In accordance with embodiments of the invention, the key 131 may include a plate that is coupled to a side of the connector 22 and the key lock 132 may be defined as a slot in the first elongate leg 112. In this case, the reception of the key 131 in the key lock 132 provides for 3 dimensional positional location and stability. In accordance with further embodiments, however, it is to be understood that the key 131 and the key lock 132 may be provided in alternate configurations. For example, the key 131 may be a pin and the key lock 132 may be a cylindrical opening in the first elongate leg 111. In this or other cases, the key and key lock feature 130 may be provided as a singular feature or as multiple features. In the latter case, each of the multiple key and key lock features 130 may be disposed along a longitudinal length of the blind mate book 20 and the guide 110.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A connector system, comprising:
a blind mate book including a chassis and a connector, which is extendable and retractable with respect to the chassis;
a mating connector operably connectable with the connector; and
a blocking system defining a pathway through which the blind mate book travels toward and from a connect position defined as a position at which the connector is operably connectable with the mating connector,
the blocking system being configured to permit connector extension upon disposition of the blind mate book in the connect position.

2. The connector system according to claim 1, wherein the connector is manually extendable and retractable.

3. The connector system according to claim 1, wherein the blocking system comprises a guide disposed proximate to the mating connector.

4. The connector system according to claim 3, wherein the connector comprises a key and the guide is formed to define a key lock, which is receptive of the key during connector extension upon disposition of the blind mate book in the connect position.

5. The connector system according to claim 4, wherein the key comprises a plate coupled to a side of the connector and the key lock is defined as a slot.

6. A connector system, comprising:
a blind mate book including a chassis and a connector, which is extendable and retractable with respect to the chassis;
a mating connector operably connectable with the connector; and
a blocking system defining a pathway through which the blind mate book travels toward and from a connect position defined as a position at which the connector is operably connectable with the mating connector;
the blocking system being configured to prevent travel of the blind mate book toward and from the connect position with the connector partially extended.

7. The connector system according to claim 6, wherein the connector is manually extendable and retractable.

8. The connector system according to claim 6, wherein the blocking system comprises a guide disposed proximate to the mating connector.

9. The connector system according to claim 8, wherein the guide comprises:
first and second legs; and
a blocking leg extending between the first and second legs to prevent travel of the blind mate book with the connector partially extended.

10. The connector system according to claim 9, wherein the blocking leg comprises a forward side and an aft side, wherein:
the forward side impinges upon a lead side of the connector to prevent travel of the blind mate book toward the connect position with the connector partially extended, and
the aft side impinges upon a trailing side of the connector to prevent travel of the blind mate book from the connect position with the connector partially extended.

11. A connector system, comprising:
a blind mate book including a chassis and a connector, which is extendable and retractable with respect to the chassis;
a mating connector operably connectable with the connector; and
a blocking system defining a pathway through which the blind mate book travels toward and from a connect position defined as a position at which the connector is operably connectable with the mating connector,
the blocking system being configured to prevent travel of the blind mate book toward and from the connect position with the connector partially extended, and to permit connector extension upon disposition of the blind mate book in the connect position.

12. The connector system according to claim 11, wherein the connector is manually extendable and retractable.

13. The connector system according to claim 11, wherein the blocking system comprises a guide disposed proximate to the mating connector.

14. The connector system according to claim 13, wherein the guide comprises:
first and second legs; and
a blocking leg extending between the first and second legs to prevent travel of the blind mate book with the connector partially extended.

15. The connector system according to claim 14, wherein the blocking leg comprises a forward side and an aft side, wherein:
the forward side impinges upon a lead side of the connector to prevent travel of the blind mate book toward the connect position with the connector partially extended, and
the aft side impinges upon a trailing side of the connector to prevent travel of the blind mate book from the connect position with the connector partially extended.

16. The connector system according to claim 15, wherein the guide is spring loaded.

17. The connector system according to claim 16, further comprising an overhang to oppose the spring loading of the guide.

18. The connector system according to claim 17, further comprising a gasket configured to be disposed between the chassis and the overhang.

19. The connector system according to claim 13, wherein the connector comprises a key and the guide is formed to define a key lock, which is receptive of the key during connector extension upon disposition of the blind mate book in the connect position.

20. The connector system according to claim 19, wherein the key comprises a plate coupled to a side of the connector and the key lock is defined as a slot.
